(19) United States
(12) Patent Application Publication
(10) Pub. No.: US 2022/0269082 A1
(43) Pub. Date: Aug. 25, 2022

(54) NEAR-EYE DISPLAY DEVICE AND WEARABLE EQUIPMENT

(71) Applicant: BOE Technology Group Co., Ltd., Beijing (CN)

(72) Inventors: Haitao HUANG, Beijing (CN); Shi SHU, Beijing (CN); Renquan GU, Beijing (CN); Zhao CUI, Beijing (CN); Liuqing LI, Beijing (CN); Yong YU, Beijing (CN); Wenqu LIU, Beijing (CN); Lina JING, Beijing (CN)

(21) Appl. No.: 17/408,042

(22) Filed: Aug. 20, 2021

(30) Foreign Application Priority Data
Feb. 25, 2021 (CN) 202110215270.4

(51) Int. Cl. G02B 27/01; G02B 3/00; G02B 27/09

(52) U.S. Cl. CPC G02B 27/0172; G02B 3/0056; G02B 27/0961; G02B 2027/0112; G02B 2027/0118

(57) ABSTRACT

A near-eye display device includes: a pixel island array, a micro-lens array, and a light condensing functional layer. The pixel island array includes one or more pixel islands, the micro-lens array includes one or more micro-lenses, and each pixel island corresponds to a corresponding micro-lens on a one-to-one basis. And the light condensing functional layer includes one or more light condensing components, the positions of the light condensing components corresponds to the position of the pixel islands, and the light condensing components are located between the corresponding pixel island and the micro-lens for condensing lights emitted by the pixel islands. The light condensing functional layer is arranged between the micro-lens array and the pixel island array, and the light condensing components is arranged in the light condensing functional layer corresponding to the pixel islands.

### CROSS-REFERENCE TO RELATED APPLICATIONS

The present application claims priority to Chinese Patent Application No. 202110215270.4 filed in China on Feb. 25, 2021, which is incorporated herein by reference in its entirety.

### TECHNICAL FIELD

The present disclosure relates to the technical field of display, and in particular to a near-eye display device and wearable equipment.

### BACKGROUND

Micro-lens pixel island plane close-to-eye display has excellent display performance, and its pixel island plane is usually imaged with RGB three-color pixel islands corresponding to each individual micro-lens, so as to reduce the problem of imaging color difference caused by the limitation of single lens aperture.

However, since the micro-display pixel island typically emits lights at a Lambert reflector angle, a portion of the light beam of the micro-display pixel island may enter the human eye from a light-transmitting region, thereby forming stray light. At the same time, the light beams of different color pixel islands also enter the human eye through the non-corresponding imaging lens, forming color difference stray light, thereby reducing the display effect and adversely affecting the user experience.

### SUMMARY

In a first aspect, embodiments of the present disclosure provide a near-eye display device including: a pixel island array, a micro-lens array, and a light condensing functional layer located between the pixel island array and the micro-lens array; and the pixel island array comprises one or more pixel islands, the micro-lens array comprises one or more micro-lenses, and each the pixel island corresponds to a corresponding the micro-lens on a one-to-one basis; the light condensing functional layer includes one or more light condensing components, the positions of the light condensing components correspond to the positions of the pixel islands, and the light condensing components are located between the corresponding pixel islands and the micro-lenses, and are used for condensing lights emitted by the pixel islands so that the lights concentrated by the light condensing components are emitted from the corresponding micro-lenses and reach a predetermined viewing position.

According to one possible embodiment of the present disclosure, the light condensing components are arranged in one-to-one correspondence with the pixel islands.

According to one possible embodiment of the present disclosure, the light condensing functional layer further includes a first substrate for carrying the light condensing components, and the material of the first substrate is a light-transmitting material.

According to one possible embodiment of the present disclosure, the light condensing components are arranged on one side of the first substrate facing the pixel island array; and/or, the light condensing components are arranged on one side of the first substrate facing the micro-lens array.

According to one possible embodiment of the present disclosure, the light condensing components include a light condensing lens and/or a refractive layer; and the condenser lens and/or the refractive layer are used to concentrate the lights emitted by the pixel islands.

According to one possible embodiment of the present disclosure, a plurality of the micro-lenses of the micro-lens array is arranged at intervals; or each adjacent pair of the micro-lenses among the plurality of the micro-lenses in the micro-lens array is arranged without a space.

According to one possible embodiment of the present disclosure, the light condensing functional layer further includes a light shielding layer; and the light shielding layer includes one or more light shielding structures, and the light shielding structures are used for shielding lights emitted from the pixel islands to the outside of the corresponding light condensing component.

According to one possible embodiment of the present disclosure, the light shielding structure corresponding to areas of the pixel islands has one or more openings, and the orthographic projection of the micro-lenses and/or the pixel islands on the first substrate is completely or partly located within the orthographic projection of the openings on the first substrate.

According to one possible embodiment of the present disclosure, the light shielding structure is a black matrix; and/or the material of the light shielding structure comprises at least a black resin.

According to one possible embodiment of the present disclosure, the light shielding layer is located on one side of the first substrate facing the micro-lens array; and/or the light shielding layer is located on one side of the first substrate facing the pixel island array.

According to one possible embodiment of the present disclosure, the micro-lens array further includes: a second substrate, wherein the micro lenses are arranged on one side of the second substrate away from the light condensing functional layer; one side of the second substrate away from the micro lenses is connected to the light condensing functional layer via a first adhesive layer.

According to one possible embodiment of the present disclosure, one side of the light condensing functional layer away from the micro-lens array is provided with a second adhesive layer, and the pixel islands are provided at one side of the second adhesive layer away from the light condensing functional layer.

According to one possible embodiment of the present disclosure, a refractive index of the refractive layer is substantially greater than that of the first substrate; and/or the refractive index of the refractive layer is substantially greater than that of the second adhesive layer.

In a second aspect, embodiments of the present disclosure also provide wearable equipment including the near-eye display device. And the near-eye display device includes: the pixel island array, the micro-lens array, and the light condensing functional layer located between the pixel island array and the micro-lens array; and the pixel island array includes one or more multiple pixel islands, the micro-lens array includes one or more micro-lenses, and each the pixel island corresponds to a corresponding the micro-lens on a one-to-one basis; the light condensing functional layer includes one or more light condensing components, the positions of the light condensing components correspond to the positions of the pixel islands, and the light condensing components are located between the corresponding pixel islands and the micro-lenses, and are used for condensing lights emitted by the pixel islands so that the lights concentrated by the light condensing components are emitted from the corresponding micro-lenses and reach a predetermined viewing position.

According to one possible embodiment of the present disclosure, the light condensing components are arranged in one-to-one correspondence with the pixel islands.

According to one possible embodiment of the present disclosure, the light condensing functional layer further includes the first substrate for carrying the light condensing components, and the material of the first substrate is the light-transmitting material.

According to one possible embodiment of the present disclosure, the light condensing components are arranged on one side of the first substrate facing the pixel island array; and/or, the light condensing components are arranged on one side of the first substrate facing the micro-lens array.

According to one possible embodiment of the present disclosure, the light condensing components include the light condensing lens and/or the refractive layer; and the condenser lens and/or the refractive layer are used to concentrate the lights emitted by the pixel islands.

According to one possible embodiment of the present disclosure, a plurality of the micro-lenses of the micro-lens array is arranged at intervals; or each adjacent pair of the micro-lenses among the plurality of the micro-lenses in the micro-lens array is arranged without a space.

According to one possible embodiment of the present disclosure, the light condensing functional layer further includes the light shielding layer; and the light shielding layer includes one or more light shielding structures, and the light shielding structures are used for shielding lights emitted from the pixel islands to the outside of the corresponding light condensing component.

According to one possible embodiment of the present disclosure, the light shielding structure corresponding to areas of the pixel islands has one or more openings, and the orthographic projection of the micro-lenses and/or the pixel islands on the first substrate is completely or partly located within the orthographic projection of the openings on the first substrate.

According to one possible embodiment of the present disclosure, the light shielding structure is the black matrix; and/or the material of the light shielding structure includes at least the black resin.

According to one possible embodiment of the present disclosure, the light shielding layer is located on one side of the first substrate facing the micro-lens array; and/or the light shielding layer is located on one side of the first substrate facing the pixel island array.

According to one possible embodiment of the present disclosure, the micro-lens array further includes: the second substrate, wherein the micro lenses are arranged on one side of the second substrate away from the light condensing functional layer; one side of the second substrate away from the micro lenses is connected to the light condensing functional layer via the first adhesive layer.

According to one possible embodiment of the present disclosure, one side of the light condensing functional layer away from the micro-lens array is provided with the second adhesive layer, and the pixel islands are provided at one side of the second adhesive layer away from the light condensing functional layer.

According to one possible embodiment of the present disclosure, the refractive index of the refractive layer is substantially greater than that of the first substrate; and/or the refractive index of the refractive layer is substantially greater than that of the second adhesive layer.

### BRIEF DESCRIPTION OF THE DRAWINGS

The foregoing and/or additional aspects and advantages of the present disclosure will become apparent and readily appreciated from the following description of embodiments in conjunction with the accompanying drawings, in which:

FIG. 1 is a schematic structural diagram of a near-eye display device using a micro-lens pixel island image plane mosaic display technique provided by the related art;

FIG. 2 is a schematic diagram illustrating an image displayed by a red pixel island and a green pixel island of a near-eye display device provided by the related art superimposed on a retina;

FIG. 3 is a schematic diagram illustrating a cross-talk of light phenomenon in a near-eye display device provided by the related art;

FIG. 4 is a front view of a near-eye display device provided by an embodiment of the present disclosure;

FIG. 5 is a schematic cross-sectional view along A-A line of FIG. 4 provided by an embodiment of the present disclosure;

FIG. 6 is a schematic structural diagram of another display device provided by an embodiment of the present disclosure;

FIG. 7 is a partial schematic structural diagram illustrating a light condensing functional layer of another near-eye display device provided by an embodiment of the present disclosure;

FIG. 8 is a schematic diagram of an inner structure of another near-eye display device provided by an embodiment of the present disclosure;

FIG. 9 is a detailed schematic structural diagram of a near-eye display device provided by an embodiment of the present disclosure;

FIG. 10 is a detailed schematic structural diagram of another near-eye display device provided by an embodiment of the present disclosure; and

FIG. 11 is a detailed schematic structural diagram of yet another near-eye display device provided by an embodiment of the present disclosure.

### DETAILED DESCRIPTION

Description will now be made in detail to the present disclosure, examples of the embodiments of the present disclosure are illustrated in the accompanying drawings, wherein the same or similar reference numerals refer to the same or similar parts or parts having the same or similar functions throughout. Furthermore, if a detailed description of known technology is not necessary for illustrating the features of the present disclosure, it is omitted. The embodiments described below with reference to the drawings are exemplary and intended to explain the disclosure and should not be explained as limits to the disclosure.

Unless otherwise defined, all terms (including technical and scientific terms) used herein have the same meaning as commonly understood by those of ordinary skill in the art to which the present disclosure belongs. It should be further understood that terms, such as those defined in commonly used dictionaries, should be interpreted as having a meaning that is consistent with their meaning in the context of the related art and will not be interpreted in an idealized or overly formal sense unless expressly so defined herein.

As used herein, the singular forms “a”, “an”, “the” and “this” may include the plural forms as well, unless expressly stated otherwise. It should be further understood that the terms “includes” and/or “including” when used in this specification, specify the presence of the features, integers, steps, operations, elements, and/or components, but do not preclude the presence or addition of one or more other features, integers, steps, operations, elements, components, and/or groups thereof. As used herein, the term “and/or” includes all or any one of one or more associated listed items and all combinations thereof.

A near-eye display technology based on virtual reality (VR) and augmented reality (AR) has become an important way to acquire information. Currently, the mainstream near-eye display optical technologies mainly include: waveguide display, free-form surface display, and integrated imaging light field display. However, each of these solutions has its own advantages and disadvantages. For example, waveguides display method is sensitive to the wavelength of incident lights and chromatic dispersion easily occurs. A waveguide optical coupling structure also has chromatic dispersion effect on external light, and “ghost image” will appear during the time of wearing. Free-form surface display method is relatively large in terms of its overall size, and is difficult to balance between large field angle and device size. Integrated imaging light field display method is difficult to achieve the transmission of external light, the augmented reality display effect of the scheme is poor.

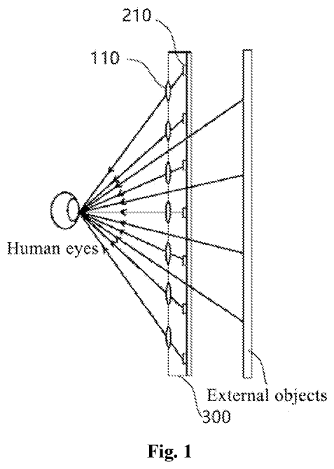

As shown in FIG. 1, there is shown a schematic structural diagram of a near-eye display device using a micro-lens pixel island image plane mosaic display technique provided by the related art. The scheme that the near-eye display is obtained by micro-lens pixel island image plane mosaic and is used as a new type of near-eye display scheme, attaches a discretized micro-lens 110 and an area micro-display pixel island 210 through a transparent substrate 300. Therefore, each set of micro-lens pixel island combinations displays a portion of the sub-images of an overall image and projects the overall image completely into the human eye by image plane mosaic. The array and area display of the discretized micro-lens 110 can ensure the transmission of outside world lights into the human eye and bring the AR enhanced display near-eye display experience for users. The overall display device is compact in size due to the attachment of the array of light-weight and thin micro-lens 110 to a micro-display. The display field angle of the device can be expanded and a wider visual experience can be realized by reasonably increasing the combination number of micro-lens pixel islands. By adjusting the focal length and spacing of the micro-lens 110, the overall device size can be effectively controlled. Therefore, the near-eye display scheme has characteristics such as more light-weight and thin and a large field of view and so on, and has become an important display scheme in the field of AR/VR in the future.

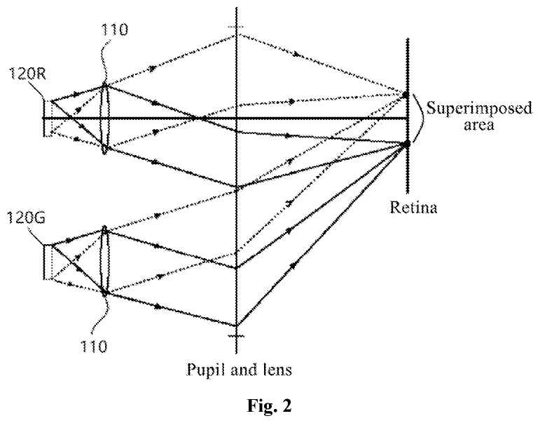

The main principle of the micro-lens pixel island image plane mosaic display is shown in FIG. 2. The image plane mosaic display consists of a plurality of groups of micro-lens pixel island units, each group displays a partial image and projects the image to the retina of a human eye. A complete image is formed on the image plane by a plurality of micro-lens pixel island combinations. Since the aperture of the micro-lens 110 is small, it is difficult to optimize the imaging aberration and color difference, so the displayed image is separated into RGB three-channel. Specifically, the green pixel island 210G is combined with one micro-lens 110, the red pixel island 210R, and another micro-lens 110, therefore different colors of the same image are displayed respectively. However, by using the convergent imaging function of the pupil and lens of the human eye, the RGB three-color images are overlapped on the retina to form a color display image. By adding more micro-lens pixel island combinations, the imaging field of view can be effectively expanded to achieve a light-weight and thin near-eye display with a large field of view, and high imaging quality.

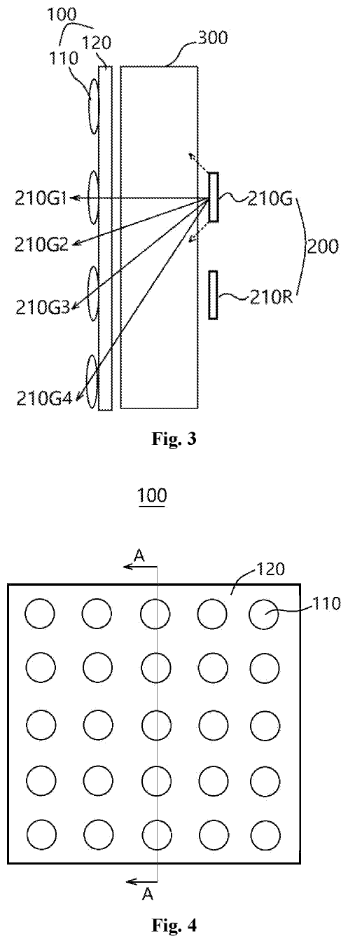

However, the micro-lens pixel island image plane mosaic display also has certain limitations, in which the light emitting direction of the pixel island 210 is generally not controlled, and the light emitting angle of the pixel island 210 is close to divergence type light emitting angle of an Lambert reflector, and therefore stray lights and cross-talk lights which violate the real imaging lights will appear. The stray light distribution of the imaging system is shown in FIG. 3, in which only green pixel island 210G and red pixel island 210R are shown, and a blue pixel island and other repeating units are not shown. The green pixel island 210G emits a diffused light beam, which will be imaged through the micro-lens array 100 surface, and the display device will simultaneously include an imaging light beam 210G1, a transparent region stray lights 210G2, a cross-color stray lights 210G3, and a cross-talk light beam 210G4 with the same color. Only the imaging beam 210G1 is the beam to be effective for the human eye required by the display device, and the others are stray or transparent region cross-talk. The transparent region stray lights 210G2 will superimpose a bright halo around the normal imaging plane, which seriously affects the display effect experiences of users. The cross-color stray lights 210G3 will superimpose cross-colors of different colors in the imaged image such that the color distribution in the image plane area is not uniform. The same color cross-talk beam 210G4 will cause superposition between the imaged images, resulting in visual ghosting and reduced contrast ratio. In addition, as shown in FIG. 3, a near-eye display device using the micro-lens pixel island image plane mosaic technology provided by the related art includes: a pixel island array 200, a micro-lens array 100, and a light condensing functional layer 300 located between the pixel island array 200 and the micro-lens array 100. Specifically the micro-lens array 100 includes a plurality of micro-lenses 110, and a corresponding substrate 120.

The present inventors have found that in a conventional near-eye display solution, the problem of stray lights is somewhat eliminated by using a polarizer in combination with a color film. However, since the loss of lights by the polarizer is large (close to 50%), the luminous efficiency of the pixel island is reduced.

Accordingly, embodiments of the present disclosure provide the near-eye display device and wearable equipment, for solving or partly solving the above-mentioned deficiencies in the related art.

Hereinafter, the technical solutions of the present disclosure and how the technical solutions of the present disclosure solve the above technical problems will be described in detail with specific embodiments.

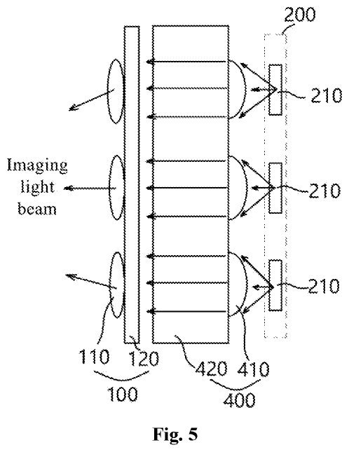

FIG. 4 provides a front view of the near-eye display device according to an embodiment of the present disclosure, and FIG. 5 provides a cross-sectional view along A-A line in FIG. 4 according to an embodiment of the present disclosure. As shown in conjunction with FIGS. 4 and 5, embodiments of the present disclosure provide the near-eye display device including: a pixel island array 200, a micro-lens array 100, and a light condensing functional layer 400 located between the pixel island array 200 and the micro-lens array 100. Here the relative positions of the pixel island array 200 and the micro-lens array 100 are fixed and spaced. Here, the spaced arrangement means that there is a space between two adjacent pixel islands or between two adjacent micro-lenses. The micro-lens array 100 includes the plurality of micro-lenses 110, which can be arranged in a plurality of rows and columns according to display requirements. Of course, it is easily understood that the array form of the plurality of micro-lenses 110 shown in FIG. 4 is only one possible example, and the plurality of micro-lenses 110 can be provided in other forms of arrangement according to actual requirements. The pixel island array 200 includes the plurality of pixel islands 210 (only three pixel islands 210 displaying different light emission colors are illustrated in FIG. 5), and each pixel island 210 is arranged in one-to-one correspondence with the corresponding micro-lens 110. Here, the so-called corresponding arrangement means that the orthographic projection of the pixel island 210 on, for example, the substrate included by the micro-lens array 100 (e.g. the second substrate 120) substantially coincides with the orthographic projection of the micro-lens 110 on, for example, the substrate included by the micro-lens array 100, or that one of the two orthographic projections substantially covers the other.

Specifically, the light condensing functional layer 400 includes at least one light condensing component 410, the position of which corresponds to the position of the pixel island 210, and which is located between the corresponding pixel island 210 and the micro-lens 110, for condensing lights emitted from the pixel island 210 so that the lights converged by the light condensing components 410 is emitted from the corresponding micro-lens 110 and reaches a predetermined viewing position. Here the predetermined viewing position refers to a position where the user's eyes are located when using the near-eye display device.

The near-eye display device according to an embodiment of the present disclosure is provided, by providing the light condensing functional layer 400 between the micro-lens array 100 and the pixel island array 200, and arranging the light condensing components 410 in the light condensing functional layer 400 corresponding to the pixel island 210, lights emitted from the pixel island 210 are condensed by the light condensing components 410, so that the lights condensed by the light condensing components 410 are emitted from the corresponding micro-lenses 110 and reach the predetermined viewing position. Thus, the lights emitted from the pixel island 210 to the area outside the corresponding micro-lenses 110 are reduced, the light cross-talk problem is avoided as much as possible, and the luminous efficiency is improved while reducing the stray light problem, thereby improving the display effect.

In some possible implementations, with continued reference to FIG. 5, to further enhance the light condensing effect and reduce light cross-talk, as a non-limiting example, the number of light condensing components 410 in embodiments of the present disclosure can be equal to the number of pixel islands 210. Furthermore, the light condensing components 410 are arranged in one-to-one correspondence with the pixel islands 210 such that lights emitted from each pixel island 210 can be condensed by the corresponding light condensing components 410 and emitted from the corresponding micro-lens 110.

In the present embodiment, the light condensing components 410 are arranged in one-to-one correspondence with the pixel islands 210, so as to ensure that the lights emitted by each pixel island 210 can be converged by the corresponding light condensing components 410, thereby improving the convergence effect of the lights emitted by each pixel island 210, thereby enabling the effective lights of the pixel island 210 to be emitted from the corresponding micro-lens 110 as much as possible, reducing the cross-talk of lights between adjacent pixel islands 210, and further improving the display effect.

In some possible implementations, with continued reference to FIG. 5, the light condensing functional layer 400 in embodiments of the present disclosure further includes the first substrate 420 for carrying the light condensing components 410. The micro-lens array 100 and the pixel island array 200 are respectively located on two opposite sides of the first substrate 420 (namely, one side of the first substrate 420 facing the micro-lens array 100 and one side of the second substrate 120 facing the pixel island array 200). In order not to affect the light transmission, the material of the first substrate 420 is selected as a light-transmitting material, for example a transparent glass or resin material.

Optionally, the light condensing components 410 can be arranged on one side of the first substrate 420 facing the pixel island array 200.

Optionally, the condensing components 410 can be arranged on one side of the first substrate 420 facing the micro-lens array 100.

Optionally, one side of the first substrate 420 facing the pixel island array 200 and one side of the first substrate 420 facing the micro-lens array 100 are both provided with the light condensing components 410.

In some possible implementations, as shown in FIG. 5, the light condensing part 410 on the first substrate 420 can all be a light condensing lens or can all be a refractive layer, and can of course also be a light condensing lens in part and a refractive layer in part. Either the light condensing lens or the refractive layer can be used to concentrate the lights emitted by the pixel island 210. Here the refractive index of the refractive layer is larger than the refractive index of the previous film layer in the direction close to the pixel island 210, for example.

It should be noted that the specific structure and material of the condensing lens or refractive layer can be selectively set according to condensing requirements of the condensing functional layer 400, which is not specifically limited in the present embodiment.

Optionally, the plurality of micro-lenses 110 in the micro-lens array 100 can all be spaced apart, with the spacing area being approximately the size of one micro-lens 110, as shown in FIG. 4.

Optionally, the plurality of micro-lenses 110 in the micro-lens array 100 in embodiments of the present disclosure can all be in an adjacent arrangement, where the adjacent arrangement means that there is no space between the micro-lenses 110 and the micro-lenses 110.

Optionally, the plurality of micro-lenses 110 in the micro-lens array 100 can also be arranged partially connected, partially spaced. For example, in the micro-lens array 100, a column of micro-lenses 110 can be arranged adjacent to each other, and a column of micro-lenses 110 can be arranged at intervals so as to be alternately arranged.

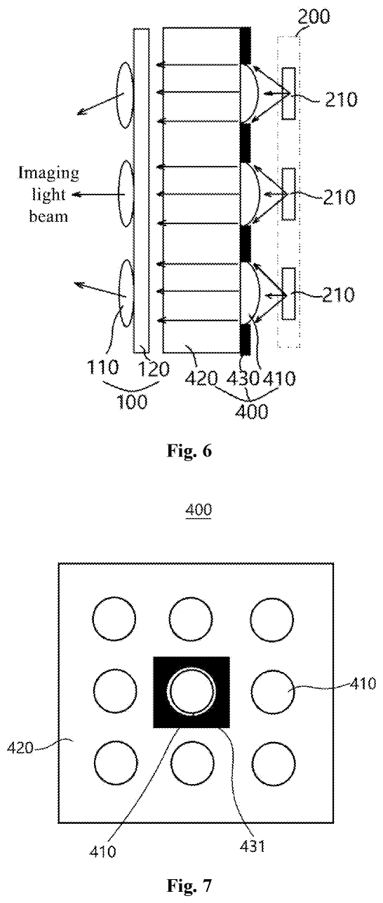

In some embodiments, as shown in conjunction with FIGS. 6 and 7, for the case where there are the plurality of micro-lenses 110 spaced apart in the micro-lens array 100, the corresponding plurality of pixel islands 210 are also spaced apart. To further reduce cross-talk of light, the light condensing functional layer 400 in embodiments of the present disclosure further includes the light shielding layer 430 including a plurality of light shielding structures 431 (only one light shielding structure 431 is illustrated in FIG. 7). Furthermore, each light shielding structure 431 corresponds to a peripheral region of the corresponding pixel island 210 for shielding lights emitted from the pixel island 210 to the outside of the light condensing components 410.

In the present embodiment, a light-shielding layer 430 is provided in the light condensing functional layer 400, and each light-shielding structure 431 of the light-shielding layer 430 can block lights emitted from the pixel island 210 to the outside of the light condensing components 410, further reducing the cross-talk of lights between adjacent pixel islands 210, thereby improving the display effect.

Optionally, the region of the light shielding structure 431 corresponding to the pixel island 210 is provided with an opening for transmitting lights, and the orthographic projection of the light condensing components 410 on the first substrate 420 is located within the orthographic projection of the opening on the first substrate 420. In addition, the orthographic projection of the micro-lens 110 and/or pixel island 210 on the first substrate 420 is located within the orthographic projection of the opening on the first substrate 420, thereby preventing lights that would be normally emitted from the pixel island 210 to the light condensing lens and the micro-lens 110 are blocked.

Optionally, the outline of the orthographic projection of the opening in the light shielding structure 431 on the first substrate 420 substantially coincides with the outline of the orthographic projection of the pixel island 210 on the first substrate 420, and it is only necessary to ensure that the size of the outline of the light shielding structure 431 is slightly larger than the size of the outline of the pixel island 210, so as to ensure that effective lights are emitted from the micro-lenses 110 after passing through the light condensing components 410, and to avoid the cross-talk of lights emitted to the area outside the corresponding micro-lenses 110 as much as possible, thereby improving the display effect.

Optionally, the light shielding structure 431 can be a Black Matrix (BM), which can be implemented according to a distributed position and means of the light condensing components 410. The material of the light shielding structure 431 includes at least the black resin to ensure the light shielding effect.

In some possible implementations, the relative position relationship between the light shielding layer 430 and the first substrate 420 can be: the light shielding layer 430 is located on one side of the first substrate 420 facing the micro-lens array 100, or the light shielding layer 430 is located on one side of the first substrate 420 facing the pixel island array 200, or the light shielding layer 430 can be manufactured by a full-scale film-forming combined with a patterning process on the first substrate 420 to obtain the light shielding structure 431 having the opening.

Optionally, in order to further enhance the light condensing effect of the light condensing functional layer 400, both the side of the first substrate 420 facing the micro-lens array 100 and the side facing the pixel island array 200 can be provided with the light shielding layer 430. Such an arrangement corresponds to that the first substrate 420 corresponding to the opening forms a transmission channel, and the light condensing components 410 are located at one side of the light-transmitting channel facing the pixel island 210 and/or one side facing the micro-lens 110.

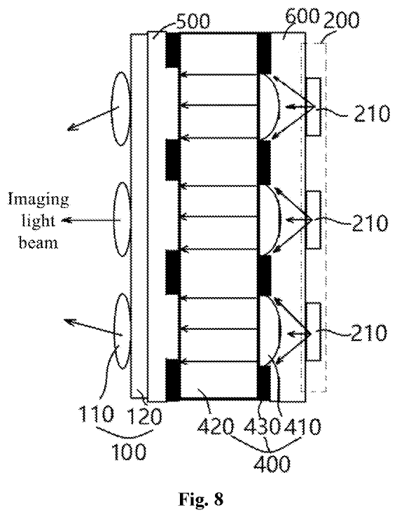

In some possible embodiments, as shown in FIG. 8, the micro-lens array 100 further includes the second substrate 120 as a carrier for the micro-lenses 110. The second substrate 120 can be formed integrally with the micro-lens 110, or the positioning of the micro-lens 110 on the second substrate 120 can be achieved by means of adhesion, adhesive tape, and so on. Specifically, the micro-lens 110 is arranged on one side of the second substrate 120 away from the light condensing functional layer 400. As a non-limiting example, one side of the second substrate 120 away from the micro-lenses 110 is connected to the light condensing functional layer 400, for example, by a first adhesive layer 500.

Specifically, the second substrate 120 is arranged opposite to the first substrate 420 in the light condensing functional layer 400, and in the case that the light condensing components 410 and the light shielding layer 430 are not provided on one side of the first substrate 420 near the micro-lens array 100, the second substrate 120 is directly connected to the first substrate 420 through the first adhesive layer 500. The second substrate 120 is connected to the light shielding layer 430 and/or the light condensing components 410 on one side of the first substrate 420 near the micro-lens array 100 through the first adhesive layer 500.

In some possible embodiments, with continued reference to FIG. 8, one side of the condensing functional layer 400 away from the micro-lens array 100 is provided with a second adhesive layer 600. The second adhesive layer 600 is located between the pixel island array 200 and the light condensing functional layer 400. In addition, the pixel islands 210 are arranged on one side of the second adhesive layer 600 away from the light condensing functional layer 400.

Optionally, considering the light condensing effect of the refractive layer, the refractive index of the refractive layer is greater than the refractive index of the previous film layer, and when the previous film layer of the refractive layer is the second adhesive layer 600 (namely, the refractive layer is located on one side of the first substrate 420 close to the second adhesive layer 600), the refractive index of the refractive layer is greater than the refractive index of the second adhesive layer 600. When the previous film layer of the refractive layer is the first substrate 420 (the refractive layer is located on one side of the first substrate 420 away from the second adhesive layer 600), the refractive index of the refractive layer is greater than the refractive index of the first substrate 420. The specific values of the refractive index of the refractive layer and the refractive index of the first substrate 420 or the second adhesive layer 600 can be selectively set according to actual display requirements, and are not specifically limited in the embodiments of the present disclosure.

Optionally, one side of the pixel island array 200 away from the second adhesive layer 600 is further provided with a back plate layer (not shown in the figures), and a switch control device (for example, a thin film transistor (TFT) device) used for controlling light emission of each pixel island 210 is provided in the back plate layer.

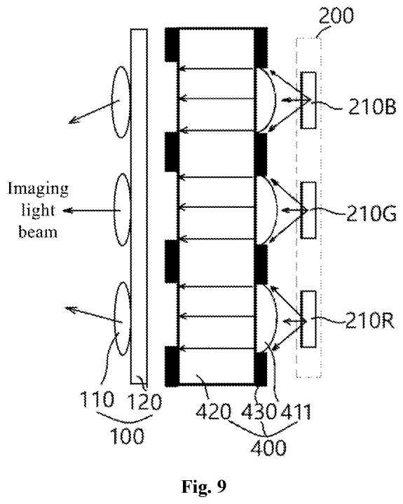

In one particular embodiment, with continued reference to FIG. 9, the near-eye display device in one embodiment of the present disclosure includes, for example: a pixel island array 200 (the pixel island array 200 includes a blue pixel island 210B, a green pixel island 210G, and a red pixel island 210R), a micro-lens array 100, and a light condensing functional layer 400. Specifically one side of the first substrate 420 close to the pixel island array 200 is provided with a patterned light shielding layer 430 (a BM layer) and a light condensing lens 411. The BM layer can block light, and the condensing lens 411 can concentrate lights at a large angle to improve light efficiency. An additional layer of the first substrate 420 can also be designed with the BM layer to further block lights and enhance the display effect, and finally an imaging beam can be formed by the micro-lens array 100, which can be used in the field of VR, for example.

Optionally, referring to FIG. 5, for the near-eye display device in the above-mentioned embodiments, the BM layer cannot be provided on both sides of the first substrate 420 so as to increase transparency and facilitate the entry of external lights so as to form a scene in which a real environment is combined with a virtual environment, which can be applied to, for example, the field of AR.

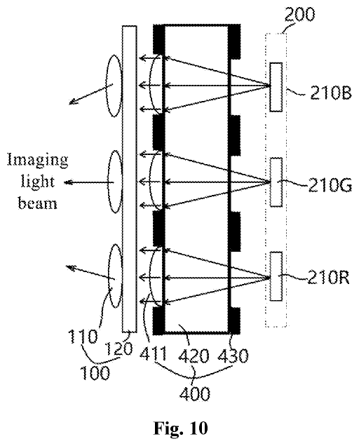

In another specific embodiment, as shown in FIG. 10, the near-eye display device in one embodiment of the present disclosure includes, for example, the pixel island array 200 (including the blue pixel islands 210B, the green pixel islands 210G, and the red pixel islands 210R), the micro-lens array 100, and the light condensing functional layer 400. Specifically one side of the first substrate 420 close to the pixel island array 200 is provided with a patterned BM layer, and the BM layer can be used to block lights. In another layer of the first substrate 420, the BM layer and the condenser lens 411 can also be designed; the condenser lens 411 can concentrate the lights of a large angle to improve the light efficiency; the BM layer can block the lights of a very large angle emitted by the pixel island 210 to prevent the generation of stray lights; and finally an imaging beam can be formed by the micro-lens array 100, which can be used in the field of VR, for example.

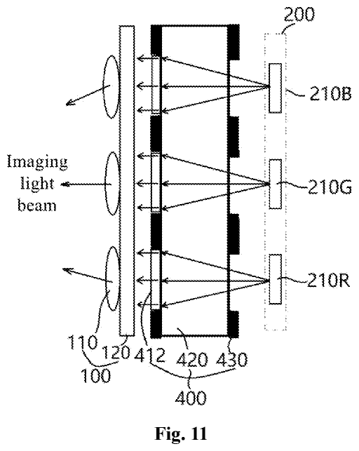

Optionally, as shown in FIG. 11, the near-eye display device in one embodiment of the present disclosure includes, for example, the pixel island array 200 (including the blue pixel islands 210B, the green pixel islands 210G, and the red pixel islands 210R), the micro-lens array 100, and the light condensing functional layer 400. Specifically one side of the first substrate 420 close to the pixel island array 200 is provided with the patterned BM layer, and the BM layer can block lights. An additional layer on the first substrate 420 can also be designed with the BM layer and a refractive layer 412. The refraction layer 412 can also concentrate the large angle lights to improve the light efficiency; the BM layer can block the lights of a very large angle emitted by the pixel island 210 to prevent the generation of stray lights; and finally, an imaging beam can be formed by the micro-lens array 100, which can be used in the field of VR, for example.

In addition, the refractive layer 412 can also be provided, for example, on one side of the first substrate 420 near the pixel island array 200, as long as the divergent lights emitted by the pixel island 210 can be concentrated.

Based on the same inventive concept, embodiments of the present disclosure also provide wearable equipment including the near-eye display device described in the embodiment of the present disclosure. The wearable equipment can for example be AR equipment or VR equipment.

Embodiments of the present disclosure provide the wearable equipment that includes the near-eye display device of the previous embodiments. The near-eye display device is arranged by providing the light condensing functional layer 400 between the micro-lens array 100 and the pixel island array 200, and the light condensing components 410 in the light condensing functional layer 400 correspond to the pixel island 210. The lights emitted from the pixel island 210 is condensed by the condensing components 410, so that the lights condensed by the condensing components 410 are emitted from the corresponding micro-lens 110 and reach the predetermined viewing position. Therefore, the lights emitted from the pixel island 210 to the area outside the corresponding micro-lens 110 are reduced, the cross-talk of the lights is avoided as much as possible, and the luminous efficiency is improved while reducing the stray light, thereby improving the display effect.

Various embodiments of the present disclosure have, for example, the following technical effects:

1. By providing the light condensing functional layer 400 between the micro-lens array 100 and the pixel island array 200, and the light condensing components 410 in the light condensing functional layer 400 correspond to the pixel islands 210. The lights emitted from the pixel islands 210 is condensed by the condensing components 410, so that the lights condensed by the condensing components 410 are emitted from the corresponding micro-lens 110 and reach the predetermined viewing position. Therefore, the lights emitted from the pixel islands 210 to the area outside the corresponding micro-lens 110 are reduced, the cross-talk of the lights is avoided as much as possible, and the luminous efficiency is improved while reducing the stray light, thereby improving the display effect.

2. The light condensing components 410 are arranged in one-to-one correspondence with the pixel islands 210, so as to ensure that the lights emitted by each pixel island 210 can be converged by the corresponding light condensing components 410, thereby improving the convergence effect of the lights emitted by each pixel island 210. Furthermore, the effective lights of the pixel islands 210 are emitted from the corresponding micro-lenses 110 as much as possible, reducing the cross-talk of lights between the pixel islands 210, and further improving the display effect.

3. The light-shielding layer 430 is provided in the light condensing functional layer 400, and each light-shielding structure 431 of the light-shielding layer 430 can block lights emitted from the pixel island 210 to the outside of the light condensing components 410. Cross-talk of lights between adjacent pixel islands 210 are thereby further reduced, thereby enhancing the display effect.

4. The outline of the orthographic projection of the opening in the light shielding structure 431 on the first substrate 420 substantially coincides with the outline of the orthographic projection of the pixel island 210 on the first substrate 420, and it is only necessary to ensure that the size of the outline of the light shielding structure 431 is slightly larger than the size of the outline of the pixel island 210, so as to ensure that effective lights are emitted from the micro-lenses 110 after passing through the light condensing components 410, and to avoid the cross-talk of lights emitted to the area outside the corresponding micro-lenses 110 as much as possible, thereby improving the display effect.

In the description of the present disclosure, it should be understood that the orientation or positional relationship indicated by the terms “center”, “upper”, “lower”, “front”, “rear”, “left”, “right”, “vertical”, “horizontal”, “top”, “bottom”, “inner”, “outer”, and the like is based on the orientation or positional relationship shown in the drawings, and is merely for convenience of describing the disclosure and simplifying the description, but not intended or implied that the referenced device or element must have a particular orientation, be constructed and operated in a particular orientation, and thus should not be construed as limiting the present disclosure.

The terms “first” and “second” are used for descriptive purposes only and are not to be construed as indicating or implying relative importance or implicitly indicating the number of technical features indicated. Therefore, features defined by “first” and “second” may explicitly or implicitly indicate inclusion of one or more such features. In the description of the present disclosure, the meaning of “a plurality of” is two or more unless otherwise specified.

In the description of the present disclosure, it should be noted that the terms “mount”, “connect” and “connected” are to be construed broadly, e.g. may be fixedly connected, removably connected, or integrally connected, may be a direct connection or an indirect connection through an intermediate medium, or a communication between two elements, unless explicitly stated or defined. The specific meanings of the above terms in the present disclosure will be understood on a case-by-case basis by those of ordinary skill in the art.

In the description of the present disclosure, particular features, structures, materials, or characteristics can be combined in any suitable manner in any one or more embodiments or examples.

While the foregoing is only part of embodiments of the present disclosure, it should be understood by those skilled in the art that various improvements and modifications may be made without departing from the principle of the present disclosure, and theses improvement and modifications shall fall within the scope of protection of the present disclosure.

What is claimed is:

1. A near-eye display device, comprising: a pixel island array, a micro-lens array, and a light condensing functional layer located between the pixel island array and the micro-lens array;
wherein the pixel island array comprises one or more pixel islands, the micro-lens array comprises one or more micro-lenses, and each the pixel island corresponds to a corresponding the micro-lens on a one-to-one basis;
the light condensing functional layer comprises one or more light condensing components, the positions of the light condensing components correspond to the positions of the pixel islands, and the light condensing components are located between the corresponding pixel islands and the micro-lenses, and are used for condensing lights emitted by the pixel islands so that the lights concentrated by the light condensing components are emitted from the corresponding micro-lenses and reach a predetermined viewing position.

2. The near-eye display device according to claim 1, wherein the light condensing components are provided in one-to-one correspondence with the pixel islands.

3. The near-eye display device according to claim 2, wherein the light condensing functional layer further comprises a first substrate which is used for carrying the light condensing components, and a material of the first substrate is a light transmitting material.

4. The near-eye display device according to claim 3, wherein the light condensing components are arranged at one side of the first substrate facing the pixel island array; and/or, the light condensing components are arranged on one side of the first substrate facing the micro-lens array.

5. The near-eye display device according to claim 2, wherein the light condensing components comprise a condensing lens and/or a refractive layer; the condenser lens and/or the refractive layer are used to concentrate the lights emitted by the pixel islands.

6. The near-eye display device according to claim 3, wherein a plurality of the micro-lenses in the micro-lens array are arranged at intervals; or
each adjacent pair of the micro-lenses among the plurality of the micro-lenses in the micro-lens array is arranged without a space.

7. The near-eye display device according to claim 6, wherein the light condensing functional layer further comprises a light shielding layer;
wherein the light shielding layer comprises one or more light shielding structures, and the light shielding structures are used for shielding lights emitted from the pixel islands to the outside of the corresponding light condensing component.

8. The near-eye display device according to claim 7, wherein a light shielding structure corresponding to areas of the pixel islands has one or more openings, and the orthographic projection of the micro-lenses and/or the pixel islands on the first substrate is completely or partly located within the orthographic projection of the openings on the first substrate.

9. The near-eye display device according to claim 7, wherein the light shielding structure is a black matrix; and/or the material of the light shielding structure comprises at least a black resin.

10. The near-eye display device according to claim 7, wherein the light shielding layer is located on one side of the first substrate facing the micro-lens array; and/or the light shielding layer is located on one side of the first substrate facing the pixel island array.

11. The near-eye display device according to claim 1, wherein the micro-lens array further comprises: a second substrate, wherein the micro lenses are arranged on one side of the second substrate away from the light condensing functional layer;
one side of the second substrate away from the micro lenses is connected to the light condensing functional layer via a first adhesive layer.

12. The near-eye display device according to claim 5, wherein one side of the light condensing functional layer away from the micro-lens array is provided with a second adhesive layer, and the pixel islands are provided at one side of the second adhesive layer away from the light condensing functional layer.

13. The near-eye display device according to claim 12, wherein a refractive index of the refractive layer is substantially greater than that of the first substrate; and/or the refractive index of the refractive layer is substantially greater than that of the second adhesive layer.

14. Wearable equipment, comprising a near-eye display device,
wherein the near-eye display device comprises: a pixel island array, a micro-lens array, and a light condensing functional layer located between the pixel island array and the micro-lens array;
wherein the pixel island array comprises one or more multiple pixel islands, the micro-lens array comprises one or more micro-lenses, and each the pixel island corresponds to a corresponding the micro-lens on a one-to-one basis;
the light condensing functional layer comprises one or more light condensing components, the positions of the light condensing components correspond to the positions of the pixel islands, and the light condensing components are located between the corresponding pixel islands and the micro-lenses, and are used for condensing lights emitted by the pixel islands so that the lights concentrated by the light condensing components are emitted from the corresponding micro-lenses and reach a predetermined viewing position.

15. The wearable equipment according to claim 14, wherein the light condensing components are arranged in one-to-one correspondence with the pixel islands.

16. The wearable equipment according to claim 15, wherein the light condensing functional layer further comprises a first substrate which is used for carrying the light condensing components, and the material of the first substrate is a light transmitting material.

17. The wearable equipment according to claim 16, wherein the light condensing components are arranged on one side of the first substrate facing the pixel island array; and/or, the light condensing components are arranged on one side of the first substrate facing the micro-lens array.

18. The wearable equipment according to claim 15, wherein the light condensing components comprise a light condensing lens and/or a refractive layer; and the condenser lens and/or the refractive layer are used to concentrate the light emitted by the pixel islands.

19. The wearable equipment according to claim 16, wherein a plurality of micro-lenses of the micro-lens array are arranged at intervals; or
each adjacent pair of the micro-lenses among the plurality of the micro-lenses in the micro-lens array is arranged without a space.

20. The wearable equipment according to claim 19, wherein the light condensing functional layer further comprises a light shielding layer;
wherein the light shielding layer comprises one or more light shielding structures, and the light shielding structures are used for shielding lights emitted from the pixel islands to the outside of the corresponding light condensing components.
